(19) United States
(12) Patent Application Publication
(10) Pub. No.: US 2005/0095364 A1
(43) Pub. Date: May 5, 2005

(54) Process for the production of coatings on substrates

(76) Inventors: Nebojsa Curcic, Wuppertal (DE); Peter Frese, Wuppertal (DE); Phu Qui Nguyen, Moenchengladbach (DE); Martin Wulf, Witten (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/700,384

(22) Filed: Nov. 3, 2003

(51) Int. Cl. B05D 1/32; B32B 15/04

(52) U.S. Cl. 427/372.2; 427/558; 427/553; 428/457

(57) ABSTRACT

A process for the production of coatings on substrates comprising the successive steps: a) providing a substrate to be coated and of a backing foil provided on one side with an uncured or at least only partially cured coating of a curable coating composition, b) applying the coated side of the backing foil provided with the uncured or at least only partially cured coating onto the substrate, c) curing the coating applied in said manner and d) removing the backing foil from the coating which remains on the substrate, wherein curing of the coating proceeds prior to and/or after removal of the backing foil and wherein the uncured or at least only partially cured coating of the curable coating composition is or has been applied onto one side of the backing foil by screen printing.

### FIELD OF THE INVENTION

The invention relates to a process for the production of coatings on substrates using backing foils provided by a screen printing process with an uncured or at least only partially cured (cross-linked) coating.

### BACKGROUND OF THE INVENTION

Backing foils coated on one side with an uncured or at least only partially cured coating composition are known from WO 03/013739 and U.S. 2003/0113444 A1. They can be used for original or repair coating of substrates, the coating layer being transferred onto the substrate and cured. As a result, only the cured coating layer remains on the substrate, but not the backing foil, which is removed before or after completion of curing.

With regard to the production of coated backing foils, WO 03/013739 and U.S. 2003/0113444 A1 explain that the curable coating compositions may be applied onto the backing foil using conventional methods, for example, by means of brushing, roller coating, flooding, knife coating or spraying, i.e., by means of conventional coating processes.

The coating processes used to produce the coated backing foils have relatively low productivity and/or operate with losses of curable coating composition due to the formation of overspray and/or are incapable of accurately producing the desired layer thickness of the coating layer of the curable coating composition that is applied onto the backing foil.

It is desirable to provide a coating process for substrates using backing foils provided in an advantageous manner with an uncured or at least only partially cured coating.

### SUMMARY OF THE INVENTION

The invention relates to a process for the production of coatings on substrates comprising the successive steps:
a) providing a substrate to be coated and of a backing foil provided on one side with an uncured or at least only partially cured coating of a curable coating composition,
b) applying the coated side of the backing foil provided with the uncured or at least only partially cured coating onto the substrate,
c) curing the coating applied in said manner and
d) removing the backing foil from the coating which remains on the substrate,
   wherein curing of the coating proceeds prior to and/or after removal of the backing foil, wherein the uncured or at least only partially cured coating of the curable coating composition is or has been applied onto one side of the backing foil by screen printing.

### DETAILED DESCRIPTION OF THE EMBODIMENTS

The substrates provided in step a) of the process according to the invention may comprise substrates of any desired coatable materials, for example, of metal, plastic, wood, glass. The substrates may be uncoated or have a single layer or a multilayer precoating, for example, a paint coating. The substrates to be coated may, for example, comprise automotive bodies, body parts or body fittings.

The backing foil provided in step a) of the process according to the invention, which is coated on one side with an uncured or at least only partially cured coating of a curable coating composition, is produced by screen printing a backing foil with the curable coating composition on one side.

A first embodiment of the process according to the invention uses a backing foil provided with a coating of a thermally curable coating composition, while a second embodiment of the process according to the invention uses a backing foil provided with a coating of a coating composition which is curable by means of high-energy radiation and is optionally additionally thermally curable.

Although it is essential to the invention for a screen printing process to be used, the present description and claims nevertheless refer to coating of a backing foil with a coating composition. While in conventional screen printing it is possible to form printing ink pixels on the print medium which are isolated from one another, the individual pixels of coating composition screen printed on the backing foil in the process according to the invention, said pixels still initially being isolated from one another, merge into a continuous coating film after removal of the printing screen.

In the case of the first embodiment of the process according to the invention, the backing foils comprise metal foils, for example, of aluminum, or preferably, foils of any desired, in particular thermoplastic, plastics. The plastics foils are preferably transparent, in particular colorless and transparent. In the case of supplying thermal energy to the coating prior to the removal of the backing foil, the plastics foils must be resistant to the temperatures that arise in the foil material on supply of thermal energy. Suitable plastics foil materials are, for example, polyolefins, such as, polyethylene, polypropylene; polyurethane; polyamide and polyesters, such as, polyethylene terephthalate and polybutylene terephthalate. The plastics foils may also consist of polymer blends.

In the case of the second embodiment of the process according to the invention, the backing foils comprise colored or colorless, in particular transparent foils of any desired, in particular thermoplastic, plastics which meet certain requirements with regard to UV (ultraviolet) transmittance and heat resistance. In the case of irradiation of the coating with UV radiation in which UV radiation is passed through the backing foil, the foils must transmit UV radiation and be resistant to the temperatures that arise in the foil material on irradiation with UV radiation. The foils must also be resistant to the temperatures optionally required for partially gelling/tackifying the applied coating layer. Suitable plastic foil materials are, for example, polyolefins, such as, polyethylene, polypropylene; polyurethane; polyamide and polyesters, such as, polyethylene terephthalate and polybutylene terephthalate. The plastics foils may also consist of polymer blends.

The backing foils may be surface-treated. It is also possible for the backing foils to have a textured surface, for example, a micro- and/or macro-textured surface. A textured foil surface, for example, is convenient if the surface of the coating layer to be applied in the process according to the invention is to exhibit corresponding textures. In this case, the side of the backing foil to be coated would comprise a negative of the appropriate textures and, after removal of the textured backing foil, the textures may then be formed as a positive in the outer surface of the outer coating layer produced using the process according to the invention. The thickness of the foils may, for example, be between 10 and 1000 μm, preferably, between 10 and 500 μm, particularly preferably, between 20 and 250 μm and is determined by practical considerations of processability.

The backing foils selected should preferably be those that are elastic and extensible and cling effectively to the substrate by electrostatic forces.

The coatings located on one side of the backing foils are curable coatings which are or have been applied from curable coating compositions by screen printing. The curable coating compositions themselves are liquid or pasty and may contain water and/or organic solvents or contain neither solvents nor water. In the latter, less preferred case, screen printing may be or have been performed with heated, for example, molten coating composition.

In the case of the first embodiment of the process according to the invention, the coatings on the backing foils are of coating compositions curable by supply of thermal energy. Examples of such thermally curable coating compositions are the coating compositions known to the person skilled in the art which contain binders curable by means of cationic and/or free-radical polymerization and/or by means of condensation reactions and/or by means of addition reactions. When selecting the binders, care must be taken to use only those thermally cross-linkable binders that are stable in storage prior to supply of thermal energy.

Thermally cationically curable coating compositions contain one or more cationically polymerizable binders. These may comprise conventional binders known to the person skilled in the art, such as, polyfunctional epoxy oligomers containing more than two epoxy groups per molecule. These comprise, for example, polyalkylene glycol diglycidyl ethers, hydrogenated bisphenol A glycidyl ethers, epoxyurethane resins, glycerol triglycidyl ether, diglycidyl hexahydrophthalate, diglycidyl esters of dimer acids, epoxidized derivatives of (methyl)cyclohexene, such as, for example, 3,4-epoxycyclohexylmethyl (3,4-epoxycyclohexane) carboxylate or epoxidized polybutadiene. The number average molar mass of the polyepoxy compounds is preferably below 10,000. Reactive diluents, such as, cyclohexene oxide, butene oxide, butanediol diglycidyl ether or hexanediol diglycidyl ether, may also be used.

The thermally cationically curable coating compositions contain one or more thermally activatable initiators. Initiators which may be used are, for example, thermolabile onium salts.

Thermally free-radically curable coating compositions contain one or more binders with free-radically polymerizable olefinic double bonds. Suitable binders having free-radically polymerizable olefinic double bonds that may be considered are, for example, all the binders known to the skilled person that can be cross-linked by free-radical polymerization. These binders are prepolymers, such as, polymers and oligomers containing, per molecule, one or more, preferably on average 2 to 20, particularly preferably 3 to 10 free-radically polymerizable olefinic double bonds. The polymerizable double bonds may, for example, be present in the form of (meth)acryloyl, vinyl, allyl, maleate and/or fumarate groups. The free-radically polymerizable double bonds are particularly preferably present in the form of (meth)acryloyl groups.

Both here and below, (meth)acryloyl or (meth)acrylic are respectively intended to mean acryloyl and/or methacryloyl or acrylic and/or methacrylic.

Examples of prepolymers or oligomers include (meth)acryloyl-functional poly(meth)acrylates, polyurethane (meth)acrylates, polyester (meth)acrylates, unsaturated polyesters, polyether (meth)acrylates, silicone (meth)acrylates, epoxy (meth)acrylates, amino (meth)acrylates and melamine (meth)acrylates. The number average molar mass Mn of these compounds may be, for example, 500 to 10,000 g/mole, preferably 500 to 5,000 g/mole. The binders may be used individually or as a mixture. (Meth)acryloyl-functional poly(meth)acrylates and/or polyurethane (meth)acrylates are preferably used.

The prepolymers may be used in combination with reactive diluents, i.e., free-radically polymerizable low molecular weight compounds with a molar mass of below 500 g/mole. The reactive diluents may be mono-, di- or polyunsaturated. Examples of monounsaturated reactive diluents include: (meth)acrylic acid and esters thereof, maleic acid and semi-esters thereof, vinyl acetate, vinyl ethers, substituted vinylureas, styrene, vinyltoluene. Examples of diunsaturated reactive diluents include: di(meth)acrylates, such as, polyethylene glycol di(meth)acrylate, 1,3-butanediol di(meth)acrylate, vinyl (meth)acrylate, allyl (meth)acrylate, divinylbenzene, dipropylene glycol di(meth)acrylate and hexanediol di(meth)acrylate. Examples of polyunsaturated reactive diluents are: glycerol tri(meth)acrylate, trimethylolpropane tri(meth)acrylate and pentaerythritol tri(meth)acrylate, pentaerythritol tetra(meth)acrylate. The reactive diluents may be used alone or in mixture.

The free-radically curable coating compositions may contain thermally activatable free-radical initiators which decompose at different temperatures, depending on the initiator type. Examples of such free-radical initiators include, organic peroxides, organic azo compounds or C—C-cleaving initiators, such as, dialkyl peroxides, peroxycarboxylic acids, peroxydicarbonates, peroxide esters, hydroperoxides, ketone peroxides, azodinitriles or benzopinacole silyl ethers. The free-radical initiators are preferably used in quantities of between 0.1 and 5 wt-%, relative to resin solids content. The thermal initiators may be used individually or in combination.

Thermally curable coating compositions that cure by means of condensation reactions and/or by means of addition reactions contain one or more binders with appropriately cross-linkable functional groups. Suitable binders are those binders or binder systems that are stable in storage prior to supply of thermal energy. One-component binder systems are preferred.

The addition and/or condensation reactions as stated above comprise coatings chemistry cross-linking reactions known to the person skilled in the art, such as, ring-opening addition of an epoxy group onto a carboxyl group forming an ester and a hydroxyl group, the reaction of a hydroxyl group with a blocked isocyanate group forming a urethane group and eliminating the blocking agent, the reaction of a hydroxyl group with an N-methylol group eliminating water, the reaction of a hydroxyl group with an N-methylol ether group eliminating the etherification alcohol, the transesterification reaction of a hydroxyl group with an ester group eliminating the esterification alcohol, the transurethanization reaction of a hydroxyl group with a carbamate group eliminating alcohol, the reaction of a carbamate group with an N-methylol ether group eliminating the etherification alcohol.

Moisture-curing binder components are also possible, for example, compounds with free isocyanate groups, with hydrolyzable alkoxysilane groups or with amino groups blocked as ketimine or as aldimine. In the event that the thermally curable coating compositions contain binders or functional groups that cure by means of atmospheric humidity, certain conditions described below must be maintained during preparation of the coated backing foils in order to avoid premature curing.

The various cross-linking mechanisms described above may be combined at will, provided that they do not mutually interfere. The various cross-linkable functional groups may here be present in the same binder and/or in separate binders. Binders that cross-link without elimination are preferably used. In particular, free-radically polymerizable binder systems are used in combination with thermal initiators. These binder systems may optionally be combined with at least one of the above-stated binder systems which cross-link by means of condensation and/or addition reactions.

In the case of the second embodiment of the process according to the invention, the coatings on the backing foils are of coating compositions curable by irradiation with high-energy radiation. These coating compositions are cationically and/or free-radically curable coating compositions known to the person skilled in the art, wherein free-radically curable coating compositions are preferred.

The coating compositions cationically curable by irradiation with high-energy radiation contain one or more cationically polymerizable binders, for example, the same as those described above in connection with the thermally cationically curable coating compositions.

The cationically curable coating compositions contain one or more photoinitiators. Photoinitiators that may be used are onium salts, such as, diazonium salts and sulfonium salts.

The coating compositions free-radically curable by irradiation with high-energy radiation contain one or more binders with free-radically polymerizable olefinic double bonds. With regard to these binders and further components with free-radically polymerizable olefinic double bonds, the same applies as has already been described above in connection with the thermally free-radically curable coating compositions.

The coating compositions free-radically curable by irradiation with high-energy radiation contain one or more photoinitiators, for example, in quantities of 0.1 to 5 wt-%, preferably of 0.5 to 3 wt-%, relative to the sum of free-radically polymerizable prepolymers, reactive diluents and photoinitiators. Examples of photoinitiators are benzoin and derivatives thereof, acetophenone and derivatives thereof, for example 2,2-diacetoxyacetophenone, benzophenone and derivatives thereof, thioxanthone and derivatives thereof, anthraquinone, 1-benzoylcyclohexanol, organophosphorus compounds, such as, acylphosphine oxides. The photoinitiators may be used individually or in combination.

It is possible for the coating compositions curable by means of high-energy radiation to contain, in addition to the binder components free-radically and/or cationically polymerizable by means of high-energy radiation, or in addition to the free-radically and/or cationically polymerizable functional groups, further binder components or further functional groups that are chemically cross-linkable by an additional curing mechanism, for example, by condensation and/or addition reactions. Further chemically cross-linking binders that may preferably be used are one-component binder systems, for example, based on OH-functional compounds and aminoplast resins and/or blocked polyisocyanates and those based on carboxy-functional and epoxy-functional compounds. Moisture-curing binder components are also possible, for example, compounds with free isocyanate groups, with hydrolyzable alkoxysilane groups or with amino groups blocked as ketimine or aldimine. In the event that the coating compositions curable by means of high-energy radiation contain binders or functional groups that cure by means of atmospheric humidity, certain conditions described below must be maintained during preparation of the coated backing foils in order to avoid premature curing. The additional functional groups and the free-radically and/or cationically polymerizable functional groups may be present in the same binder and/or in separate binders.

The coating compositions used to coat the backing foil by screen printing may comprise pigmented or unpigmented coating compositions. Unpigmented coating compositions are, for example, coating compositions formulated in conventional manner as clear coats. Pigmented coating compositions contain color-imparting and/or special effect-imparting pigments. Suitable color-imparting pigments are any conventional coating pigments of an organic or inorganic nature. Examples of inorganic or organic color-imparting pigments are titanium dioxide, micronized titanium dioxide, iron oxide pigments, carbon black, azo pigments, phthalocyanine pigments, quinacridone or pyrrolopyrrole pigments. Examples of special effect-imparting pigments are metal pigments, for example, made from aluminum or copper; interference pigments, such as, metal oxide coated metal pigments, titanium dioxide coated mica.

The coating compositions used in screen printing may also contain transparent pigments, soluble dyes and/or extenders. Examples of usable extenders are silicon dioxide, aluminum silicate, barium sulfate, calcium carbonate and talc.

The coating compositions may also contain conventional coating additives. Examples of conventional coating additives include levelling agents, rheological agents, such as, highly disperse silica or polymeric urea compounds, thickeners, for example, based on partially cross-linked, carboxy-functional polymers or on polyurethanes, defoamers, wetting agents, anticratering agents, catalysts, antioxidants and light stabilizers based on HALS (hindered amine light stabilizer) products, sterically hindered morpholin-2-one derivatives, in particular, morpholin-2-one derivatives sterically hindered by 3,3,5,5 polysubstitution and/or UV absorbers. The additives are used in conventional amounts known to the person skilled in the art.

The backing foil is screen printed on one side with the liquid, curable coating composition over its entire surface or only in one or more sub-areas. As with conventional screen printing, printing may be performed continuously or discontinuously. After removal of the printing screen from the backing foil, the pixels of the coating composition formed during screen printing, which are initially isolated from one another, coalesce and merge to form a coating in the form of a continuous coating film.

If a coating composition melt has been used for the screen printing, a cooling operation follows, while in the more usual case of using a liquid coating composition, a drying process generally follows, over the course of which liquid components, such as solvent and/or water, are allowed to flash off. The coating must in no event be completely crosslinked during the drying process.

Merging to form a continuous coating film may be influenced by various parameters known to the person skilled in the art. Examples of such parameters are viscosity and surface tension of the coating composition and of the backing foil, the nature of the printing screen, the temperature during the actual screen printing operation and during the flashing off and/or merging subsequent to the screen printing operation and the time allowed for merging. The viscosity of the coating composition during the actual screen printing operation, when stated as a flow time (DIN EN ISO 2431, DIN 4 cup, 20° C.), is, for example, in the range from 50 to 300 seconds. The surface tension of the coating composition used is, for example, in the range from 15 to 37 mN/m and below the surface tension of the backing foil of, for example, 20 to 40 mN/m. The printing screens may be made from metal, in particular, from stainless steel, or from plastics, for example, polyester or polyamide, and comprise, for example, 5 to 200, in particular 20 to 150, wires or threads per linear centimeter with wire or thread diameters of, for example, 10 to 50 μm. The actual screen printing operation generally proceeds within a temperature range from 20 to 40° C., while, when coating composition melts are used, correspondingly higher temperatures may prevail. Flashing off and merging proceed, for example, at temperatures of 20° C. to 100° C. A period of 1 to 15 minutes is generally allowed for flashing off and merging.

The continuous coating film may take the form of a continuous layer (extensive printing of backing foil) or, if the backing foil is to be used to apply an image onto a substrate, the mirror image of the image. In the latter case, only part of the area of the backing foil is screen printed using a correspondingly designed printing screen or a corresponding stencil which produces a mirror image of the image. The corresponding design of the printing screen may be achieved by corresponding arrangement and correspondingly varied mesh size or, for example, by (partial) closure of selected meshes or mesh areas of a per se homogenous printing screen with suitable agents, such as, for example, by application of radiation-curable material, corresponding partial exposure and subsequent removal of uncured material in order to achieve (partial) closure of meshes.

Screen printing conventionally proceeds only once, but it may also be performed twice or more in succession by repeatedly screen printing the coating composition onto the continuous and dried coating film formed by the preceding screen printing step.

The uncross-linked coating should advantageously be at least slightly tacky at room temperature in order to ensure good adhesion onto the substrate. The coating may either be intrinsically tacky, for example, due to specially formulated binders or tackiness may be achieved by slight partial cross-linking/gelling of the coating, for example, depending on the system by gentle heating and/or by UV irradiation.

In general, the coatings of the curable coating compositions are applied onto the backing foils to dry layer thicknesses of 3 to 150 μm, preferably of 5 to 100 μm.

It may be advantageous to apply the coating with a layer thickness that reduces towards the edges of the backing foil so that, when it is subsequently applied, edge marks on the substrate surface are avoided. Such layer thickness gradients may be produced by several repetitions of the screen printing operation, each time using a smaller printing screen or by using correspondingly designed printing screens or corresponding stencils. Correspondingly designed printing screens can be obtained using the same principle as described above in relation to application of an image.

In order to facilitate subsequent removal of the backing foil prior to or after the supply of thermal energy onto the coating or prior to or after irradiation of the coating with high-energy radiation, it may be advantageous to leave at least one edge zone of the backing foil uncoated. It may also be advantageous to provide a special finish on the side of the backing foil that is to be coated, for example, a release coating, or to use special surface-treated foils, for example, foils surface-modified with silicate layers, in order, on removal of the backing foil, to facilitate detachment from the coating that is fixed to the substrate.

It may also be advantageous to provide the coated backing foil with a temporary protective foil to provide protection. The protective foil may here be present only on the coated side of the backing foil, but it may also be applied onto both sides and completely enclose the entire coated backing foil. The latter possibility would in particular be advisable in the event of presence of the above-described moisture-curing binder or functional groups in order to exclude atmospheric humidity. In order to facilitate detachment of the protective foil, it too may be provided with non-stick properties, as described above.

The coated backing foils, optionally provided with protective foil or protective envelope, may be prefabricated and stored in the most varied shapes and sizes, for example, in sizes of 0.5 cm² to 5 m². The coated backing foils may also be stored as a reel of continuous foil.

The coated backing foils may be cut into pieces of the correct size adapted to the coating task before use or they are already correctly dimensioned, for example, in the form of a set of correctly dimensioned coated backing foils.

The coated backing foils are used in processes according to the invention in order to perform coating tasks, such tasks possibly comprising the production of any desired coating layers for the purposes of original coating, the performance of repair coating or the provision of images, such as, for example, patterns, pictures, logos or the like, on substrate surfaces.

While the provision of images on substrate surfaces inevitably entails coating only part of the accessible substrate surface, such is not necessarily case for original or repair coating. For example, original or repair coating of a part or the entirety of the accessible substrate surfaces may be performed, wherein in particular in the case of repair coating of part of the surface, the area of the substrate to be repaired will generally have to be prepared, for example, by sanding of the blemished area to be repaired, before repair coating is carried out by the process according to the invention.

Original coating may comprise the application of any desired coating layer, in particular the application of an outer coating layer of a multilayer coating, for example, a pigmented top coat layer, a transparent clear coat or a transparent sealing layer.

Repair coating may comprise the repair of a large or small blemished area in any desired coating layer, for example, in a primer, primer surfacer, base coat, top coat or clear coat layer.

In step b) of the process according to the invention, the coated side of the coated backing foils is applied onto the substrate. The coated backing foils are applied by lamination, preferably under pressure and optionally with heating and the coating is thus attached to the substrate. This may in particular be achieved by using devices known from laminate production which have optionally been suitably modified, for example, with a heatable roll, for example, a rubber roll.

Once the coated side of the coated backing foil has been applied onto the substrate, the coating is cured in step c) of the process according to the invention by supply of thermal energy to the coating (first embodiment of the process according to the invention) or the coating is irradiated with high-energy radiation (second embodiment of the process according to the invention).

In the first embodiment of the process according to the invention, the supply of thermal energy may proceed prior to removal of the backing foil, for example, through the backing foil, and/or the coating is exposed to thermal energy after removal of the backing foil. When using systems comprising binders cross-linkable by means of condensation reactions, thermal energy is advantageously supplied only once the backing foil has been removed since the elimination products arising during the cross-linking reaction may otherwise be disruptive.

Thermal energy (heat) may be supplied to the coating in various ways, in each case providing a temperature in the coating for a period of time sufficient to cure (crosslink) the coating. The person skilled in the art knows or knows how to determine and how to provide the temperature/time conditions required for cross-linking the various thermally curable coating systems. Supply of thermal energy according to process step c) may proceed using a single method or a combination of two or more conventional methods, for example, by radiant heating by means of infrared and/or near infrared irradiation and/or by convection, for example, by means of hot air and/or by induction heating (in the case of metallic substrates) and/or by contact heating, for example, using a heatable heat-transfer means, such as, a heatable roller or plate which is applied or laid directly on the uncoated outer side of the coated backing foil.

When supplying thermal energy prior to the removal of the backing foil, the foil is removed in process step d) after the energy has been supplied. To this end, the coating is advantageously first allowed to cool before the foil is removed.

One particular form of the first embodiment of the process according to the invention consists in effecting a partial cure of the coating by initially supplying thermal energy prior to the removal of the backing foil and, once the foil has been removed, effecting final curing in a second energy supply step. In other words, the dose of thermal energy required for complete cure is supplied in at least two separate steps.

In the second embodiment of the process according to the invention, irradiation of the coating with high-energy radiation may proceed through the backing foil and/or the coating is irradiated after removal of the backing foil. UV radiation or electron beam radiation may be used as high-energy radiation. UV radiation is preferred. Irradiation may proceed continuously or discontinuously (in cycles).

Depending upon the coating task in each single case UV irradiation may be carried out, for example, in a belt unit fitted with one or more UV radiation emitters or with one or more UV radiation emitters positioned in front of the object to be irradiated, or the area to be irradiated, or the substrate to be irradiated and/or the UV radiation emitter(s) is (are) moved relative to one another during irradiation. For example, the substrate to be irradiated may be moved through an irradiation tunnel fitted with one or more UV radiation emitters, and/or a robot equipped with one or more UV radiation emitters may guide the UV radiation emitter(s) over the substrate surface. Particularly in workshops it is also possible to use UV hand lamps.

In principle, the duration of UV irradiation, distance from the object and/or radiation output of the UV radiation emitter may be varied during UV irradiation. The preferred source of UV radiation comprises UV radiation sources emitting in the wavelength range from 180 to 420 nm, in particular, from 200 to 400 nm. Examples of such continuously operating UV radiation sources are optionally doped high, medium and low pressure mercury vapour emitters and gas discharge tubes, such as, for example, low pressure xenon lamps. However, it is also possible to use discontinuous UV radiation sources. These are preferably so-called high-energy flash devices (UV flash lamps for short). The UV flash lamps may contain a plurality of flash tubes, for example, quartz tubes filled with inert gas, such as, xenon. The UV flash lamps have an illuminance of, for example, at least 10 megalux, preferably, from 10 to 80 megalux per flash discharge. The energy per flash discharge may be, for example, 1 to 10 kJoule.

The irradiation time with UV radiation when UV flash lamps are used as the UV radiation source may be, for example, in the range from 1 millisecond to 400 seconds, preferably, from 4 to 160 seconds, depending on the number of flash discharges selected. The flashes may be triggered, for example, about every 4 seconds. Curing may occur, for example, by means of 1 to 40 successive flash discharges.

If continuous UV radiation sources are used, the irradiation time may be, for example, in the range from a few seconds to about 5 minutes, preferably less than 5 minutes.

The distance between the UV radiation sources and the substrate surface to be irradiated may be, for example, 5 to 60 cm.

Irradiation with UV radiation may proceed in one or more successive irradiation steps. In other words, the energy to be applied by UV irradiation may be supplied completely in a single irradiation step or in portions in two or more irradiation steps.

When the coatings are irradiated by means of UV radiation, in particular with UV flash lamps, temperatures may be generated on or in the coating that are such that, in the event that the coatings cure by an additional cross-linking mechanism as well as UV-induced polymerization, they give rise to at least partial curing by means of this additional cross-linking mechanism.

In order to cure the coatings by means of the additional cross-linking mechanism, the coatings may, however, also be exposed to relatively high temperatures of, for example, 60 to 140° C. to cure completely. Complete curing may take place by conventional methods, for example, in an oven or in a conveyor unit, for example, with hot air and/or infrared radiation. Depending upon the curing temperature, curing times of 1 to 60 minutes are possible. The additional thermal curing can be performed prior to, during and/or after irradiation with high-energy radiation. An appropriately heat-resistant foil material must be selected depending upon the curing temperatures required for the additional thermal curing.

For coatings that are curable by irradiation-induced free-radical and/or cationic polymerization but not enhanced by an additional crosslinking mechanism, it may be expedient to supply additional thermal energy to support the curing.

In the preferred case of UV irradiation through the backing foil, the foil is removed after irradiation. In the case of additional thermal curing, it is expedient, if the coating is first allowed to cool before the foil is removed.

One particular form of the second embodiment of the process according to the invention consists in partial curing of the coating by irradiation (by means of irradiation induced free-radical and/or cationic polymerization) through the backing foil and performing final curing in a second irradiation step after removal of the foil. In other words, the radiation dose required for complete cure (by means of irradiation induced free-radical and/or cationic polymerization) is supplied in at least two separate irradiation steps.

In the event that the coating contains binders that cure by an additional cross-linking mechanism, it is possible, for example, in a first step completely or partially to cure the coating with regard to the free-radical and/or cationic polymerization by means of irradiation and, after removal of the foil, firstly to perform any outstanding final curing with regard to free-radical and/or cationic polymerization by means of irradiation and then to supply thermal energy for further curing by means of the additional cross-linking mechanism. It is, however, also possible to perform thermal curing before radiation curing.

The sequence of process steps b) to d) may also be performed several times in succession by applying two or more coatings in succession onto the substrate using backing foils provided with identical or different coatings.

Once a coating has been applied and cured by the process according to the invention, one or more further layers, in particular coating layers, may be applied.

The process according to the invention may be used in industrial coating and in vehicle coating and in each case both for original or repair coating and for providing substrate surfaces with patterns, pictures, logos or the like. Use in workshops, such as, for example, automotive repair shops or body shops, is also possible.

In particular thanks to the use of backing foils coated by means of screen printing, it is possible with the process according to the invention to produce coatings of a layer thickness which may be established extremely accurately and reproducibly. The process according to the invention furthermore also makes it possible to produce coatings with layer thickness gradients or coatings in the form of images.

### EXAMPLE

pbw=parts by weight
wt-%=weight-%.

### Example 1

### Production of a Transparent Sealing Layer on an Automotive Multilayer Coating Using a Backing Foil Provided with a Thermally Curable Coating

A polyurethane resin curable by free-radical polymerization was first produced as follows:

369.4 pbw of isophorone diisocyanate were combined with 0.6 pbw of methylhydroquinone and 80 pbw of butyl acetate and heated to 80° C. A mixture of 193 pbw of hydroxyethyl acrylate and 0.5 pbw of dibutyltin dilaurate was added dropwise in such a manner that the reaction temperature did not rise above 100° C. 50 pbw of butyl acetate were used to rinse out the dropping funnel. The temperature was maintained at a maximum of 100° C. until an NCO-value of 10.1 was obtained. 300 pbw of a polycaprolactone triol (Capa 305 from Interox Chemicals) and 50 pbw of butyl acetate were then added. The reaction mixture was maintained at a maximum of 100° C. until an NCO-value of <0.5 was obtained. The mixture was then diluted with 69.6 pbw of butyl acetate. A colorless, highly viscous resin with a solids content of 75 wt-% (1 h/150° C.) and a viscosity of 10,000 mPas was obtained.

A thermally curable clear coat was then produced from the following constituents:
80.8 wt-% of the acryloyl-functional polyurethane resin produced above,
   1.3 wt-% of a commercially available thermolabile peroxide free-radical initiator (Trigonox® 21 from Akzo),
   0.1 wt-% of a conventional commercial levelling agent (Ebecryl®) 350/UCB)
   0.8 wt-% of a conventional commercial UV absorber (Tinuvin® 384/CIBA)
   0.8 wt-% of a conventional commercial light stabilizer (HALS based) (Tinuvin®) 292/CIBA)
16.2 wt-% of butyl acetate.

The resultant clear coat was then screen printed onto one side of a 20 μm thick polyester foil. The nylon yarn printing screen used (thread diameter 20 μm) had 120 threads per linear centimeter. The clear coat applied by printing was dried for 10 minutes at 60° C. to evaporate the solvent and, during this period, merged into a continuous film with a dry layer thickness of 20 μm. A slightly tacky, no longer flowable surface was obtained.

An appropriate piece (20 cm×15 cm) of the above-coated foil was placed with its coated side down onto one half of a 20 cm×30 cm metal test panel which had been coated with a typical automotive multi-layer coating comprising electrodeposited primer, surfacer coat, base coat and clear coat.

The coating layer was then heated through the backing foil with an IR radiation emitter to approximately 80° C. and laminated without bubbles under gentle pressure. The still warm and softened coating material was then irradiated through the backing foil for 20 minutes and cured by means of a conventional commercial infrared radiation emitter (emission spectrum maximum: 2,4 μm; 20 kW/m²; Heraeus) at a distance of 40 cm. The foil was then peeled off.

### Example 2

### Production of a Transparent Sealing Layer on an Automotive Multilayer Coating Using a Backing Foil Provided with a Coating Curable by UV Irradiation

A clear coat was produced as in Example 1, except that a conventional commercial photoinitiator (Irgacure® 184, CIBA) was used instead of the peroxide free-radical initiator.

Using this clear coat, a coated backing foil was then produced and used in a similar manner as in Example 1. The only difference was that in the present case curing did not proceed by infrared irradiation of the still warm and softened coating material, but instead by irradiation through the film with 5 flashes by means of a UV flash lamp (3000 Ws) at a distance of 20 cm. The flashes were triggered every 4 seconds. Thereafter the backing foil was peeled off and the coating layer remaining on the panel was postcured by means of additional 10 flashes.

In both Example 1 and Example 2, the halves of the surface sealed with the coating layers which had been transferred from the coated backing foils onto the multilayer coatings and cured were distinguished by increased scratch and acid resistance in comparison with the unsealed halves.

1. A process for the production of coatings on substrates comprising the successive steps:
a) providing a substrate to be coated and a backing foil provided on one side with an uncured or at least only partially cured coating of a curable coating composition,
b) applying the coated side of the backing foil provided with the uncured or at least only partially cured coating onto the substrate,
c) curing of the coating applied in said manner and
d) removing the backing foil from the coating which remains on the substrate,
wherein curing of the coating proceeds prior to and/or after removal of the backing foil and wherein the uncured or at least only partially cured coating of the curable coating composition being applied onto one side of the backing foil by screen printing.

2. The process of claim 1, wherein the curable coating composition is a thermally curable coating composition and curing proceeds in step c) by supply of thermal energy by means of a method selected from the group consisting of radiant heating, convection, induction heating, contact heating and any combination thereof.

3. The process of claim 1, wherein the curable coating composition is a coating composition curable by means of high-energy radiation and the curing in step c) with high-energy radiation is selected from the group consisting of electron beam radiation and UV radiation.

4. The process of claim 1, wherein the curable coating composition is a coating composition curable thermally and by means of high-energy radiation and the curing in step c) proceeds by supply of thermal energy by means of a method selected from the group consisting of radiant heating, convection, induction heating, contact heating and any combination thereof and with high-energy radiation selected from the group consisting of electron beam radiation and UV radiation.

5. The process of claim 1, wherein the curable coating composition contains at least one binder with free-radically polymerizable olefinic double bonds.

6. The process of claim 1, wherein the curable coating composition contains at least one binder which is crosslinkable by means of reactions selected from the group consisting of condensation reactions, addition reactions and combinations thereof.

7. The process of claim 1, wherein the substrates provided in step a) are selected from the group consisting of vehicle bodies, body parts and body fittings.

8. The process of claim 1, wherein the coating applied onto the substrate is applied for the purposes of original coating, repair coating or provision of the substrate with an image.

9. Substrates provided with a coating using the process of claim 1.
